(19) United States
(12) Patent Application Publication
(10) Pub. No.: US 2016/0141999 A1
(43) Pub. Date: May 19, 2016

(54) SYSTEM AND METHOD FOR ESTIMATING TEMPERATURE OF DRIVE MOTOR

(71) Applicant: Hyundai Motor Company, Seoul (KR)

(72) Inventors: Dongyeon Han, Seoul (KR); Myung Kyu Jeong, Seoul (KR); Young Jin Seo, Yongin (KR); Hyoungjun Cho, Seoul (KR)

(21) Appl. No.: 14/751,587

(22) Filed: Jun. 26, 2015

(30) Foreign Application Priority Data
Nov. 17, 2014 (KR) 10-2014-0160330

(51) Int. Cl. H02P 29/00

(52) U.S. Cl. CPC H02P 29/0044

(57) ABSTRACT

A system for estimating a temperature of a drive motor may include: a drive motor that generates driving torque; a detector that detects a d-axis voltage, a q-axis voltage, a d-axis current, and a q-axis current of the drive motor; and a controller that determines whether zero-current control of the drive motor is performed from the d-axis current and the q-axis current detected by the detector, calculates a no-load counter-electromotive force of the drive motor from the d-axis voltage and the q-axis voltage detected by the detector, converts the no-load counter-electromotive force into a counter-electromotive force with respect to a reference rotation speed, calculates a temperature variation of the drive motor from the counter-electromotive force with respect to the reference rotation speed and a reference counter-electromotive force, and estimates the temperature of the drive motor.

### CROSS-REFERENCE TO RELATED APPLICATION

This application claims under 35 U.S.C. §119(a) the benefit of Korean Patent Application No. 10-2014-0160330 filed in the Korean Intellectual Property Office on Nov. 17, 2014, the entire contents of which are incorporated herein by reference.

### BACKGROUND

(a) Technical Field

The present invention relates to a system and method for estimating a temperature of a drive motor, more particularly, to a system for estimating the temperature of the drive motor and a method that estimates the temperature of the drive motor by using a counter-electromotive force while zero-current control of the drive motor is performed.

(b) Description of the Related Art

In general, a hybrid vehicle or an electric vehicle, each of which is referred to as an environmentally-friendly vehicle, can be driven by an electric motor (hereinafter referred to as a “drive motor”) that produces torque from electrical energy.

The hybrid vehicle is driven in an electric vehicle (EV) mode that is a pure electric vehicle mode which uses only power from the drive motor, or in a hybrid electric vehicle (HEV) mode that uses both torque of an engine and torque of the drive motor.

In general, an electric vehicle is driven using torque of the drive motor. As the drive motor, which is used as a power source for the environmentally-friendly vehicle, a permanent magnet synchronous motor (PMSM) is generally used. The permanent magnet synchronous motor has a stator, a rotor which is disposed to have a predetermined air gap with the stator, and permanent magnets which are installed to the rotor.

Depending on a method of installing the permanent magnets to the rotor, the permanent magnet synchronous motor includes two types: a surface permanent magnet motor (SPMM) in which the permanent magnets are installed on a surface of the rotor, and an interior permanent magnet synchronous motor (IPMSM) in which the permanent magnets are embedded in the rotor.

An inductance characteristic and a magnetic flux characteristic of a permanent magnet are changed by ambient temperature and heat generated in the drive motor according to driving conditions. When the inductance characteristic and the magnetic flux characteristic of the permanent magnet are changed, torque control performance of the drive motor is deteriorated.

Therefore, in order to exhibit optimal power performance and drivability, it needs to compensate a torque variation according to a temperature variation of the drive motor.

Further, when temperature of the drive motor exceeds a predetermined reference temperature, control logic for protecting related parts of the drive motor should be performed.

To this end, in the related art, temperature of the drive motor is measured through an additional temperature sensor, such as an NTC thermistor (Negative Temperature Coefficient Thermistor) or a PTC thermistor (Positive Temperature Coefficient Thermistor) disposed in the drive motor.

However, since the additional temperature sensor should be disposed in the drive motor, overall manufacturing cost of the vehicle is increased.

The above information disclosed in this Background section is only for enhancement of understanding of the background of the invention and therefore it may contain information that does not form the prior art that is already known in this country to a person of ordinary skill in the art.

### SUMMARY

The present invention provides a system and method for estimating a temperature of a drive motor capable of estimating the temperature of the drive motor through control logic without using an additional temperature sensor.

A system for estimating temperature of a drive motor according to an exemplary embodiment of the present invention may include: a drive motor that generates driving torque; a detector that detects a d-axis voltage, a q-axis voltage, a d-axis current, and a q-axis current of the drive motor; and a controller that determines whether zero-current control of the drive motor is performed from the d-axis current and the q-axis current detected by the detector, calculates a no-load counter-electromotive force of the drive motor from the d-axis voltage and the q-axis voltage detected by the detector, converts the no-load counter-electromotive force into a counter-electromotive force with respect to a reference rotation speed, calculates a temperature variation of the drive motor from the counter-electromotive force with respect to the reference rotation speed and a reference counter-electromotive force, and estimates a temperature of the drive motor.

The no-load counter-electromotive force during zero-current control may be calculated from an equation E₀=ω·φ₀, wherein w is a rotation speed of the drive motor and φ₀ is load magnetic flux linkage.

The no-load counter-electromotive force during zero-current control may be calculated from an equation E₀=ω·φₐ, wherein w is a rotation speed of the drive motor and φₐ is a no-load magnetic flux linkage.

The counter-electromotive force with respect to the reference rotation speed may be calculated from an equation

$${E}_{predetermined} = {E}_{0} \times ( \frac{reference rotation speed}{R P M} ) ,$$

wherein Epredetermined is the counter-electromotive force with respect to the reference rotation speed of the no-load counter-electromotive force and E0 is the no-load counter-electromotive force of the drive motor.

The temperature variation of the drive motor may be calculated from an equation E_{predetermined}=E_{std}×(1−0.0011×ΔT), wherein Epredetermined is the counter-electromotive force with respect to the reference rotation speed of the no-load counter-electromotive force and Estd is a counter-electromotive force at room temperature and at a reference rotation speed.

A method for estimating temperature of a drive motor according to another exemplary embodiment of the present invention may include: detecting, by a detector, a control voltage and a control current of a drive motor; determining, by a controller, whether the drive motor is under zero-current control from the control current; calculating, by the controller, a no-load counter-electromotive force of the drive motor from the control voltage when zero-current control of the drive motor is performed; and estimating, by the controller, a temperature of the drive motor from the no-load counter-electromotive force.

The no-load counter-electromotive force during zero-current control may be calculated from an equation E₀=ω·φ₀, wherein w is a rotation speed of the drive motor and φ₀ is load magnetic flux linkage.

The no-load counter-electromotive force during zero-current control may be calculated from an equation E₀=ω·φₐ, wherein w is a rotation speed of the drive motor and φₐ is a no-load magnetic flux linkage.

The estimating temperature of the drive motor may include converting the no-load counter-electromotive force into a counter-electromotive force with respect to a reference rotation speed; calculating a temperature variation of the drive motor from the counter-electromotive force and a reference counter-electromotive force; and calculating a temperature of the drive motor from the temperature variation and a reference temperature.

The no-load counter-electromotive force conversion into a counter-electromotive force with respect to a reference rotation speed may be calculated

$${E}_{predetermined} = {E}_{0} \times ( \frac{reference rotation speed}{R P M} ) ,$$

from an equation wherein Epredetermined is the counter-electromotive force with respect to the reference rotation speed of the no-load counter-electromotive force and E0 is the no-load counter-electromotive force of the drive motor.

The temperature variation of the drive motor may be calculated from an equation E_{predetermined}=E_{std}×(1−0.0011×ΔT), wherein Epredetermined is the counter-electromotive force with respect to the reference rotation speed of the no-load counter-electromotive force and Estd is a counter-electromotive force at room temperature and at a reference rotation speed.

The method may further include performing protection logic for protecting the drive motor when the temperature of the drive motor is greater than a predetermined temperature.

A non-transitory computer readable medium containing program instructions executed by a processor can include: program instructions that detect a control voltage and a control current of a drive motor; program instructions that determine whether the drive motor is under zero-current control from the control current; program instructions that calculate a no-load counter-electromotive force of the drive motor from the control voltage when zero-current control of the drive motor is performed; and program instructions that estimate a temperature of the drive motor from the no-load counter-electromotive force.

According to an exemplary embodiment of the present invention, since the temperature of the drive motor is measured through control logic without using an additional temperature sensor, it is possible to reduce manufacturing cost of the vehicle.

### BRIEF DESCRIPTION OF THE DRAWINGS

The drawings are provided for reference in describing an exemplary embodiment of the present invention, so it should not be construed that the technical spirit of the present invention is limited to the accompanying drawings.

FIG. 1 is a block diagram illustrating a system for estimating temperature of a drive motor according to an exemplary embodiment of the present invention.

FIG. 2 is a flowchart illustrating a method for estimating temperature of a drive motor according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In describing the present invention, parts that are not related to the description will be omitted. Like reference numerals generally designate like elements throughout the specification.

In addition, the size and thickness of each configuration shown in the drawings are arbitrarily shown for better understanding and ease of description, but the present invention is not limited thereto. In the drawings, the thickness of layers, films, panels, regions, etc., are exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, a system for estimating temperature of a drive motor will be described in detail with reference to accompanying drawings.

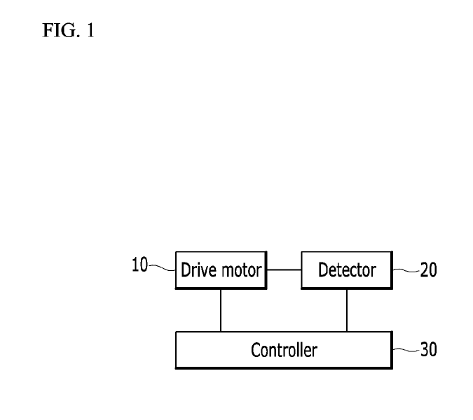

FIG. 1 is a block diagram illustrating a system for estimating temperature of a drive motor according to an exemplary embodiment of the present invention.

As shown in FIG. 1, a system for estimating a temperature of a drive motor according to an exemplary embodiment of the present invention includes a drive motor 10 that generates driving torque, a detector 20 that detects a control voltage and a control current of the drive motor 10, and a controller 30 that estimates the temperature of the drive motor 10 from a line voltage of the drive motor 10.

The detector 20 detects a control voltage (d-axis voltage, q-axis voltage) and a control current (d-axis current, q-axis current) of the drive motor 10, and supplies the control voltage and the control current to the controller 30.

The controller 30 preferably is at least one microprocessor which is executed by a predetermined program and/or hardware which includes the microprocessor. The predetermined program may be formed of a series of commands which perform a method for estimating temperature of the drive motor according to an exemplary embodiment of the present invention, which will be described below.

The controller 30 calculates a no-load counter-electromotive force from the line voltage of the drive motor 10 while zero-current control of the drive motor 10 is performed, converts the no-load counter-electromotive force into a counter-electromotive force with respect to a reference rotation speed, and estimates a temperature variation of the drive motor 10 from the counter-electromotive force with respect to the reference rotation speed and the reference counter-electromotive force.

In particular, the controller 30 may calculate a counter-electromotive force of the drive motor 10 through a following procedure while the zero-current control of the drive motor 10 is performed.

The line voltage of the drive motor 10 can be calculated from the following equation.

Vₐ=\sqrt{V_{d}²+V_{q}²}=\sqrt{(Rₐ·i_{d}−ω·L_{q}·i_{q})²+(Rₐ·i_{q}+ωL_{d}·i_{d}+ωφₐ)²} (Equation 1)

Here, Va is a line voltage of the drive motor 10, Vd is a d-axis voltage of the drive motor 10, Vq is a q-axis voltage of the drive motor 10, Ra is a phase resistance of the drive motor 10, id is a d-axis current of the drive motor 10, w is a rotation speed of the drive motor 10, Lq is a q-axis inductance of the drive motor 10, iq is a q-axis current of the drive motor 10, and [symbol] is a no-load magnetic flux linkage of the drive motor 10 (i.e., the no-load magnetic flux linkage is a magnetic flux linkage caused by a permanent magnet, or a magnetic flux linkage when the d-axis current and the q-axis current are not supplied).

When the zero-current control of the drive motor 10 is performed, the d-axis current and the q-axis current are zero. Therefore, the line voltage of the drive motor 10 can be expressed as the following Equation 2.

Vₐ=\sqrt{V_{d}²+V_{q}²}=ω·φₐ=ω·φ₀=E₀ (Equation 2)

Here, Va is a line voltage of the drive motor 10, Vd is a d-axis voltage of the drive motor 10, Vq is a q-axis voltage of the drive motor 10, w is a rotation speed of the drive motor 10, [symbol] is a no-load magnetic flux linkage of the drive motor 10 (i.e., the no-load magnetic flux linkage means a magnetic flux linkage caused by a permanent magnet of the drive motor), φ₀ is a load magnetic flux linkage of the drive motor 10 (i.e., the load magnetic flux linkage means a magnetic flux linkage caused by synthesis of a field magnet and an armature or a magnetic flux linkage when the d-axis current and the q-axis current are supplied to the drive motor), and E0 is a counter-electromotive force of the drive motor.

When the zero-current control of the drive motor 10 is performed, the d-axis current and the q-axis current are zero. Therefore, the load magnetic flux linkage and the no-load magnetic flux linkage have the same value.

The controller 30 converts the no-load counter-electromotive force of the drive motor 10 calculated from Equation 2 into a counter-electromotive force with respect to a reference rotation speed. If it is assumed that the reference rotation speed is 1000 RPM, the no-load counter-electromotive force can be converted into the counter-electromotive force with respect to the reference rotation speed through the following Equation 3.

$${E}_{1 , 000} = {E}_{0} \times ( \frac{1 \text{,} 000}{R P M} ) \qquad ( Equation 3 )$$

Here, E0 is a counter-electromotive force of the drive motor 10, and E1,000 is the E0 converted into a voltage with respect to the reference rotation speed of 1000 RPM.

As described above, it is possible to estimate the temperature variation of the drive motor 10 through a relationship between the converted voltage and the reference counter-electromotive force after the counter-electromotive force of the drive motor 10 is converted into the counter-electromotive force with respect to the reference rotation speed. The relationship between the converted voltage and the reference counter-electromotive force is expressed as the following Equation 4.

E_{1,000}=E_{std}×(1−0.0011×ΔT) (Equation 4)

Here, E1,000 is E0 converted into a voltage with respect to a reference rotation speed of 1000 RPM, Estd is a reference counter-electromotive force, and ΔT is a temperature variation of the drive motor 10. The reference counter-electromotive force is a counter-electromotive force of the drive motor 10 at room temperature (25 degrees Celsius) and 1000 RPM.

Equation 4 is determined by experiment. When a specification of the drive motor 10, the Estd is determined with respect to a reference temperature (25 degrees Celsius) and a reference rotation speed (1000 RPM).

It is possible to estimate current temperature of the drive motor 10 by compensating the temperature variation of the drive motor 10 calculated by Equation 4 to room temperature (25 degrees Celsius). For example, when the ΔT calculated from Equation 4 is 5 degrees Celsius, a current temperature of the drive motor 10 becomes 30 degrees Celsius by adding ΔT (5 degrees Celsius) to the reference temperature (25 degrees Celsius).

Hereinafter, a method for estimating temperature of a drive motor according to an exemplary embodiment of the present invention will be described in detail with reference to accompanying drawings.

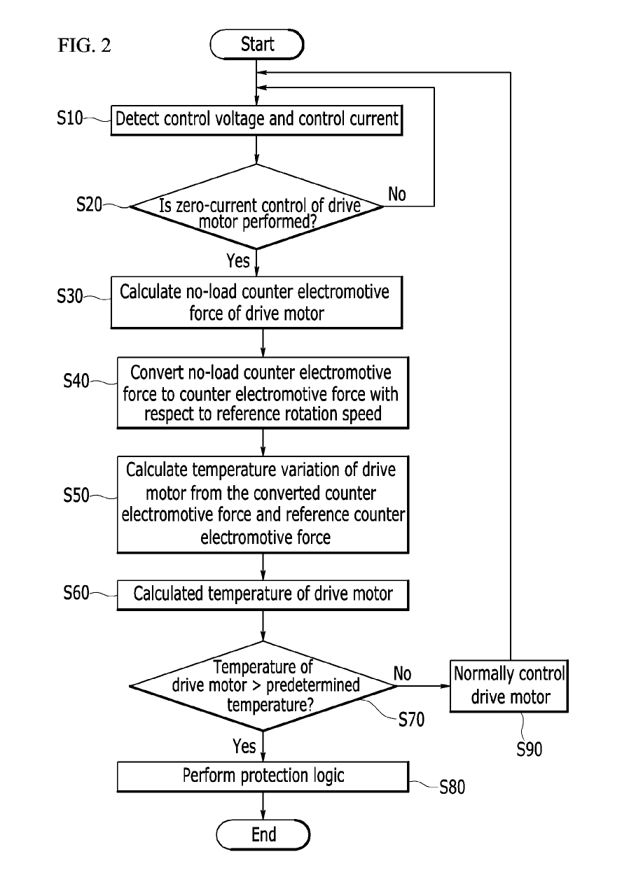

FIG. 2 is a flowchart illustrating a method for estimating temperature of a drive motor according to an exemplary embodiment of the present invention.

As shown in FIG. 2, the detector 20 detects a control voltage (d-axis voltage and q-axis voltage) and a control current (d-axis current and q-axis current) of the drive motor 10 at step S10.

The controller 30 determines whether the zero-current control of the drive motor 10 is performed from the control current (d-axis current and q-axis current) detected by the detector 20 at step S20.

When the zero-current control of the drive motor 10 is performed, the controller 30 calculates a no-load counter-electromotive force of the drive motor 10 from the control voltage (d-axis voltage and q-axis voltage) detected by the detector 20 at step S30. The counter-electromotive force of the drive motor 10 may be calculated from Equation 2.

The controller 30 estimates the temperature of the drive motor 10 from the no-load counter-electromotive force of the drive motor 10.

In detail, the controller 30 converts the no-load counter-electromotive force calculated from Equation 2 into the counter-electromotive force of the drive motor 10 with respect to the reference rotation speed by using Equation 3 at step S40.

The controller 30 calculates the temperature variation of the drive motor 10 from the counter-electromotive force and the reference counter-electromotive force at step S50. The temperature variation of the drive motor 10 may be calculated from Equation 4.

The controller 30 estimates current temperature of the drive motor 10 by compensating the temperature variation to the reference temperature (25 degrees Celsius of room temperature) at step S60.

The controller 30 determines whether the temperature of the drive motor 10 is greater than a predetermined temperature at step S70.

When the temperature of the drive motor 10 is greater than the predetermined temperature, the controller 30 performs protection logic for protecting the drive motor 10 from overheating at step S80. The protection logic for protecting the drive motor 10 may be that the current supplied to a rotor of the drive motor 10 is limited under a predetermined value. However, the protection logic is not limited thereto, and it may be replaced with another method.

When the temperature of the drive motor 10 is less than the predetermined temperature, the controller 30 normally controls the drive motor 10 at step S80.

As described above, according to an exemplary embodiment of the present invention, it is possible to estimate the temperature of the drive motor 10 without using an additional temperature sensor. Therefore, it is possible to reduce manufacturing cost of the vehicle by reducing the number of parts.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for estimating a temperature of a drive motor, comprising:
a drive motor that generates driving torque;
a detector that detects a d-axis voltage, a q-axis voltage, a d-axis current, and a q-axis current of the drive motor; and
a controller that determines whether zero-current control of the drive motor is performed from the d-axis current and the q-axis current detected by the detector, calculates a no-load counter-electromotive force of the drive motor from the d-axis voltage and the q-axis voltage detected by the detector, converts the no-load counter-electromotive force into a counter-electromotive force with respect to a reference rotation speed, calculates a temperature variation of the drive motor from the counter-electromotive force with respect to the reference rotation speed and a reference counter-electromotive force, and estimates the temperature of the drive motor.

2. The system of claim 1, wherein
the no-load counter-electromotive force during zero-current control is calculated from an equation E₀=ω·φ₀,
wherein w is a rotation speed of the drive motor and φ₀ is load magnetic flux linkage.

3. The system of claim 1, wherein
the no-load counter-electromotive force during zero-current control is calculated from an equation E₀=ω·φₐ,
wherein w is a rotation speed of the drive motor and φₐ is a no-load magnetic flux linkage.

4. The system of claim 1, wherein
the counter-electromotive force with respect to the reference rotation speed is calculated from an equation
$${E}_{predetermined} = {E}_{0} \times ( \frac{reference rotation speed}{R P M} ) ,$$
wherein Epredetermined is the counter-electromotive force with respect to the reference rotation speed of the no-load counter-electromotive force and E0 is the no-load counter-electromotive force of the drive motor.

5. The system of claim 1, wherein
the temperature variation of the drive motor is calculated from an equation E_{predetermined}=E_{std}×(1−0.0011×ΔT),
wherein Epredetermined is the counter-electromotive force with respect to the reference rotation speed of the no-load counter-electromotive force and Estd is a counter-electromotive force at room temperature and at a reference rotation speed.

6. A method for estimating a temperature of a drive motor, comprising the steps of:
detecting, by a detector, a control voltage and a control current of a drive motor;
determining, by a controller, whether the drive motor is under zero-current control from the control current;
calculating, by the controller, a no-load counter-electromotive force of the drive motor from the control voltage when zero-current control of the drive motor is performed; and
estimating, by the controller, the temperature of the drive motor from the no-load counter-electromotive force.

7. The method of claim 6, wherein
the no-load counter-electromotive force during zero-current control is calculated from an equation E₀=ω·φ₀,
wherein w is a rotation speed of the drive motor and φ₀ is load magnetic flux linkage.

8. The method of claim 6, wherein
the no-load counter-electromotive force during zero-current control is calculated from an equation E₀=ω·φₐ,
wherein w is a rotation speed of the drive motor and φₐ is a no-load magnetic flux linkage.

9. The method of claim 6, wherein
the step of estimating the temperature of the drive motor comprises:
converting the no-load counter-electromotive force into a counter-electromotive force with respect to a reference rotation speed;
calculating a temperature variation of the drive motor from the counter-electromotive force and a reference counter-electromotive force; and
calculating the temperature of the drive motor from the temperature variation and a reference temperature.

10. The method of claim 9, wherein
the no-load counter-electromotive force conversion into a counter-electromotive force with respect to a reference rotation speed is calculated from an equation
$${E}_{predetermined} = {E}_{0} \times ( \frac{reference rotation speed}{R P M} ) ,$$
wherein Epredetermined is the counter-electromotive force with respect to the reference rotation speed of the no-load counter-electromotive force and E0 is the no-load counter-electromotive force of the drive motor.

11. The method of claim 9, wherein
the temperature variation of the drive motor is calculated from an equation E_{predetermined}=E_{std}×(1−0.0011×ΔT),
wherein Epredetermined is the counter-electromotive force with respect to the reference rotation speed of the no-load counter-electromotive force and Estd is a counter-electromotive force at room temperature and at a reference rotation speed.

12. The method of claim 6, further comprising
performing protection logic for protecting the drive motor when the temperature of the drive motor is greater than a predetermined temperature.

13. A non-transitory computer readable medium containing program instructions executed by a processor, the computer readable medium comprising:
program instructions that detect a control voltage and a control current of a drive motor;
program instructions that determine whether the drive motor is under zero-current control from the control current;
program instructions that calculate a no-load counter-electromotive force of the drive motor from the control voltage when zero-current control of the drive motor is performed; and
program instructions that estimate a temperature of the drive motor from the no-load counter-electromotive force.
